(19) United States
(12) Patent Application Publication
(10) Pub. No.: US 2014/0320859 A1
(43) Pub. Date: Oct. 30, 2014

(54) MEASUREMENT APPARATUS AND METHOD

(71) Applicant: University of Strathclyde, Glasgow (GB)

(72) Inventors: Suresh N. Thennadil, Glasgow (GB); Yi-Chieh Chen, Glasgow (GB)

(21) Appl. No.: 14/358,653

(22) PCT Filed: Nov. 21, 2012
(86) PCT No.: PCT/GB2012/052873

§ 371 Date: May 15, 2014

(30) Foreign Application Priority Data
Nov. 21, 2011 (GB) 1120075.5

(51) Int. Cl. G01N 21/03; G01N 21/55; G01N 21/59

(52) U.S. Cl. CPC G01N 21/03; G01N 21/59; G01N 21/55; G01N 2021/558
USPC 356/432; 356/445

(57) ABSTRACT

A measurement system (5) comprises a radiation source (10) and a detection system (15), wherein the radiation source is arranged such that radiation from the radiation source is incident on a sample (25) and the detection system is configured to receive at least part of the radiation via the sample, wherein the system is reconfigurable so as to vary a path length that the radiation travels through the sample and/or a reflectance of at least one surface upon which the radiation is incident after passing through at least part of the sample. A property of the sample may be determined based on at least the first and second measurements.

The present invention relates to a measurement apparatus and method. Particularly, the invention relates to an optical measurement apparatus and method, for example, for characterising and/or monitoring of bulk optical properties of a sample, which may be in the form of suspensions, powders and/or tissue.

### BACKGROUND

Near infra-red spectroscopy and other optical analysis techniques are commonly used in applications such as process control and quality monitoring in industries such as pharmaceuticals, food and agriculture products, cosmetics, paints and dyes, medical diagnostics and environmental control.

The instrumentation used in such applications includes spectrometers that are built for producing single measurements. Such instrumentation can include systems that are operable in a transmission mode or systems that operate in a reflectance mode.

An example of equipment used in such measurements is described by U.S. Pat. No. 7,868,049, which describes use of an integrating sphere in conjunction with a light occluding slider that moves in front of a sample in order to block portions of diffuse light scattered from the sample. The reflectance of the sample for the area blocked by the light occluding slider can be determined by subtracting measurements of diffuse reflectance with the slider in place from measurements of diffuse reflectance without the slider in place.

U.S. Pat. No. 4,186,838 describes apparatus for measuring optical properties of a sample by separately taking measurements of a sample within and outside of an integrating sphere.

GB1439165 describes determining optical properties of a powder by measuring the reflectance of the powder sample relative the reflectance of a reference by taking measurements at first and second wavelengths.

Software tools may be used for analysing such measurement data, often by employing empirical methods. These methods work better for liquids than for powders and suspensions. Furthermore, it is desirable to extract a wider range of information from such analyses.

It at least one object of at least one embodiment of the present invention to provide an improved method or apparatus for determining optical properties of samples.

### STATEMENTS OF INVENTION

According to a first aspect of the present invention is a measurement system comprising a radiation source and a detection system, wherein the radiation source is arranged or arrangeable such that radiation from the radiation source is incident on a sample and/or sample holder and the detection system is configured or configurable to receive at least part of the radiation via the sample and/or sample holder, wherein the system is reconfigurable so as to vary a path length that the radiation travels through the sample and/or sample holder and/or a reflectance of at least one surface upon which the radiation is incident after passing through at least part of the sample and/or sample holder.

The measurement system may comprise the sample holder, which may be configured to receive the sample. The measurement system may be configured such that at least part of the radiation from the radiation source passes through at least part of the sample.

The radiation may comprise electromagnetic radiation. Preferably the system is an optical system and the radiation comprises light. The radiation may lie in an infra-red, near infra red ultraviolet and/or visible region of the spectrum.

The measurement system may be configured to collect at least a first measurement of radiation that has passed through at least a first path length through the sample and/or been reflected from a surface having a first reflectance after passing through at least part of the sample. The measurement system may be configured to collect a second measurement of radiation that has passed through at least a second path length through the sample and/or has been reflected from a surface having a second reflectance after passing through at least part of the sample. The measurement system may be configured to determine a property of the sample based on at least the first and second measurements. The first path length may vary from the second path length. The first reflectance may vary from the second reflectance.

The measurement system may be configured to make multiple measurements, each measurement being associated with a different radiation path length through the sample and/or reflectivity of a surface from which the radiation has been reflected after passing through at least a part of the sample relative to at least one and preferably each other measurement.

The sample holder may comprise a sample chamber for holding the sample. The sample holder may comprise a cuvette or cell. The sample chamber may be divided or dividable into sections, for example, in order to vary the path length through the sample. The sample holder may comprise at least one fitting for receiving a divider for dividing the sample chamber, for example, in order to vary the path length through the sample and/or the reflectivity. The system may comprise at least one divider for dividing the sample chamber. The system may be configured such that at least the first and second path lengths are defined by differing divider positions.

The at least one divider and/or a back wail of the sample holder may comprise a facing surface, which may be configured or configurable to face the radiation source. The facing surface may comprise a reflective or mirrored surface. The facing surface may comprise a diffuse reflective surface. The divider may comprise an opaque or blackened surface. The divider may comprise a transmissive or transparent surface. The transmissive or transparent surface may comprise glass, quartz or the like.

The divider may be movable within the sample chamber, for example, in order to vary the path length through the sample. The divider may be slideable or translatable within the sample chamber. The divider may be mounted to a movable member, such as a plunger or slider. The plunger may pass through a wall of the sample chamber. The system may comprise a seal for sealing between the plunger and the sample chamber wall. The plunger may comprise at least one marker for marking a range of motion of the plunger.

The plunger may comprise at least one stopping member for limiting the motion of the divider at a predetermined position in the sample chamber. The predetermined position may be a position remote from a all of the sample chamber. The predetermined position may at least partially define the first path length.

The divider may be movable to at least a further position where the motion of the divider is limited, which may be a position where the divider abuts a portion of the sample chamber, such as a rear wall of the sample chamber, which may be a wail furthest from the light source. The further position may at least partially define the second path length.

The measurement system may comprise interchangeable sample holders of varying dimensions. At least the first and second path lengths may be defined by the dimensions of differing sample holders and/or the first and second reflectivities may be defined by differing reflectivities of at least one surface of differing sample holders.

The detection system may comprise an integrating sphere. The detection system may comprise a spectrograph or spectrometer, which may comprise a monochromator and a detector or detector array, such as a CCD detector array.

The detection system may be movable relative to the sample holder and/or radiation source. The detection system may be movably mounted on guide apparatus. The detection system may be mounted on movable guide apparatus. The guide apparatus may comprise a track or rail. The movable guide apparatus may comprise a pivotable member and/or swing arm.

The sample holder may be movable or removable. The guide apparatus or a housing may comprise placing means or fixing points for mounting the sample holder in a predetermined position and/or orientation. For example, the sample holder and the guide apparatus or the housing may comprise mutually engaging portions, such as a plurality of projections and/or corresponding recesses, such that when the sample holder has been removed, it may be re-mounted to the guide apparatus or housing in the at least one predetermined position and/or orientation.

The detection system may be linearly movable and/or may be movable between at least two collinear positions.

The detection system may be movable between a side of the sample holder towards the radiation source, which may be a reflection detection side, and a side of the sample holder opposite or away from the radiation source, which may be a transmission side.

The guide apparatus may comprise at least one and preferably at least two stopping means for limiting motion of the detection system in a corresponding predetermined position or positions.

In this way, the apparatus may be straightforwardly switched between an arrangement where the detection system is positioned between the radiation source and sample, i.e. in an arrangement for taking diffuse reflectance measurements, and an arrangement where the sample is positioned between the radiation source and the detection system, i.e. in an arrangement for taking diffuse transmittance measurements. This arrangement allows both reflectance and transmittance measurements to be made by the same apparatus without the need for two sets of lenses and/or other detection system components such as the integrating sphere. Furthermore, with the system as described above, the sample holder and detection system may be repeatably and consistently positioned in predetermined positions relative to the radiation source, such that the radiation beam incident on the sample is of the same size and shape for each measurement.

The apparatus may comprise, or be configured to communicate with, processing apparatus. The processing apparatus may comprise a processor, memory and/or communication means. The processing apparatus may be adapted to determine at least one property of the sample based on two or more measurements taken by the optical measurement system, wherein each of the two or more measurements are associated with a different sample path length and/or different reflectances.

The processing apparatus may be configured to determine the at least one property of the sample by fitting theoretically calculated optical parameters, such as reflectances and/or transmittances based on a trial model, against the two or more measurements, for example, by using techniques such as monte-carlo methods, simulated annealing, partial least squares, neural networks or the like.

The processing apparatus may be configured to determine at least one property by comparing measurement data with reference data, which may be stored in a database or look up table. The reference data may comprise data collected using standard samples and/or calculated data, such as data calculated using the adding-doubling method.

The detection system may comprise at least one optical fibre. One or more of the optical fibres may be comprised in a measurement probe. At least one optical fibre may be spaced apart from at least one other optical fibre. At least one optical fibre may be oriented and/or located so as to receive radiation from the radiation source that has travelled a different path length through the sample to the radiation detected by at least one other of the optical fibres. At least one optical fibre may be oriented at a different angle relative to at least one other optical fibre, for example such that measurements at two or more angles of incidence may be performed. The one or more optical fibres may be connected or connectable to a multiplexer. The multiplexer may be connected to the spectrograph, such that the spectrograph is operable to record the intensity of radiation received by an optical fibre selected using the multiplexer.

The measurement probe may comprise at least one light emitter, which may comprise an end of an optical fibre, the optical fibre being connected or connectable to the radiation source. At least one light emitter may be oriented obliquely to at least one other light emitter and/or at least one optical fibre for detecting.

The spectrograph may be configured to determine radiation intensity at a number of wavelengths. Optionally a plurality of spectrographs may be connected to the multiplexer. At least one of the spectrographs may be operable over a different spectral range to at least one of the other spectrographs, for example, to broaden the range of wavelengths that can be detected.

At least one of the spectrographs may comprise a UV-Visible range spectrograph. At least one of the spectrographs may comprise a near infra red and/or infra red spectrograph.

The system may be configured to collect both reflected and transmitted radiation, which may correspond to respective first and second measurements.

According to a second embodiment of the present invention is a method of collecting optical measurements using a measurement system comprising a radiation source and detection system, the method comprising:
configuring the system such that radiation from the radiation source passes through a sample along a first path length and/or is reflected from a surface having a first reflectivity;
performing at least a first measurement that comprises measuring radiation from the sample after having passed through the first path length and/or having being reflected from the surface having the first reflectivity;
configuring the system such that radiation from the radiation source passes through the sample along a second path length and/or is reflected from a surface having a second reflectivity;
performing at least a second measurement that comprises measuring radiation from the sample after having passed through the second path length and/or having being reflected from the surface having the second reflectivity;
determining at least one property of the sample from at least the first and second measurements.

According to a third aspect of the present invention is an optical measurement system comprising a radiation source and detection system, wherein the detection system is mounted to a guide for moving the detection system between at least two collinear positions.

The detection system may be linearly movable.

The system may comprise a sample holder.

The detection system may be movable between a side of the sample holder towards the radiation source, which may be a reflection detection side, and a side of the sample holder away from the radiation source, which may be a transmission side.

The guide may comprise at least one and preferably at least two stopping means for limiting motion of the detection system in a corresponding predetermined position or positions.

The sample holder may be movable or removable.

The optical measurement system may comprise a housing.

The guide or housing may comprise placing means or fixing points for mounting the sample holder to the guide in a predetermined position and/or orientation. For example, the sample holder and the guide or housing may comprise mutually engaging portions, such as a plurality of projections and/or corresponding recesses, such that when the sample holder has been removed, it may be re-mounted to the guide or housing in the at least one predetermined position and/or orientation.

According to a fourth aspect Of the invention is a processing system for processing measurements collected using a measurement apparatus according to the first and/or third aspects or a method according to the second aspect.

According to a fifth aspect of invention is a computer program product for implementing the system of the first, third and/or fourth aspects and/or the method of the second aspect.

According to a sixth aspect of the present invention is a computer readable medium comprising the computer program product of the fifth aspect or computing or processing apparatus when loaded with the computer program product of the fifth aspect.

According to a seventh aspect of the present invention is a sensor probe comprising two or more optical fibres for detecting radiation from a sample, wherein the at least one of the optical fibres is spaced apart from at least one other optical fibre and/or at least one optical fibre is angled with respect to at least one other of the optical fibres.

At least one and preferably each optical fibre for detecting radiation is coupled or configured to be coupled to a detector, such as a spectrograph, which coupling may be via a multiplexer.

The sensor probe may comprise at least one light emitter. The light emitter may comprise an end of an optical fibre, wherein the optical fibre is configured to receive light from a light source, e.g. the optical fibre may be connected or connectable to a light source.

The sensor probe may be a sensor probe for use with the system of the first and/or third aspect and/or for use in the method of the second aspect.

According to an eighth aspect of the invention is a sample holder, the sample holder comprising a sample chamber for holding the sample, wherein the sample chamber is divided or dividable into sections and/or the sample fickler comprises a movable divider for varying a dimension of the sample chamber.

The sample holder may comprise at least one fitting for receiving a divider for dividing the sample chamber. The sample holder may comprise at least one divider for dividing the sample chamber. The sample holder may be configured such that at least first and second path lengths are defined by differing divider positions.

The at least one divider and/or a back wall of the sample holder may comprise a facing surface. The facing surface may comprise a reflective or mirrored surface. The facing surface may comprise a diffuse reflective surface. The divider may comprise an opaque or blackened surface. The divider may comprise a transmissive or transparent surface. The transmissive or transparent surface may comprise glass, quartz or the like.

The divider may be slidable or translatable within the sample chamber. The divider may be mounted to a movable member, such as a plunger or slider. The plunger may pass through a wall of the sample chamber. The sample holder may comprise a seal for sealing between the plunger and the sample chamber wail. The plunger may comprise at least one marker for marking a range of motion of the plunger.

The plunger may comprise at least one stopping member for limiting the motion of the divider at a predetermined position in the sample chamber. The predetermined position may be a position remote from a wall of the sample chamber. The predetermined position may at least partially define the first path length.

The divider may be movable to at least a further position where the motion of the divider is limited, which may be a position where the divider abuts a portion of the sample chamber, such as a rear wall of the sample chamber. The further position may at least partially define the second path length.

It will be appreciated that features analogous to those described above in relation to any of the above aspects may be equally applicable to any of the other aspects. Apparatus features analogous to those described above in relation to a method and method features analogous to those described above in relation to an apparatus are also intended to fall within the scope of the present invention.

### BRIEF DESCRIPTION OF THE DRAWINGS

Examples of the present invention will be described in relation to the following drawings:

FIG. 1 is a schematic of an embodiment of an optical measurement system;

FIG. 2 is a schematic of an embodiment of a sample chamber;

FIG. 3a is a schematic of an embodiment of an optical measurement system in a first configuration;

FIG. 3b is a schematic of the optical measurement system of FIG. 3a in a second configuration;

FIG. 4 is schematic of an embodiment of an optical measurement system;

FIG. 5 is a schematic of a probe of the optical measurement system of FIG. 4;

FIG. 6 is a bottom view of the probe of FIG. 5;

FIG. 7 is a flowchart of a method of collecting optical data;

FIGS. 8(a), 8(b) and 8(c) show examples of measurements from the multiple path length settings; and

FIGS. 9(a) and 9(b) show examples of results of bulk optical properties extracted from the measurements in FIGS. 8(a) to 8(c).

### DETAILED DESCRIPTION OF THE DRAWINGS

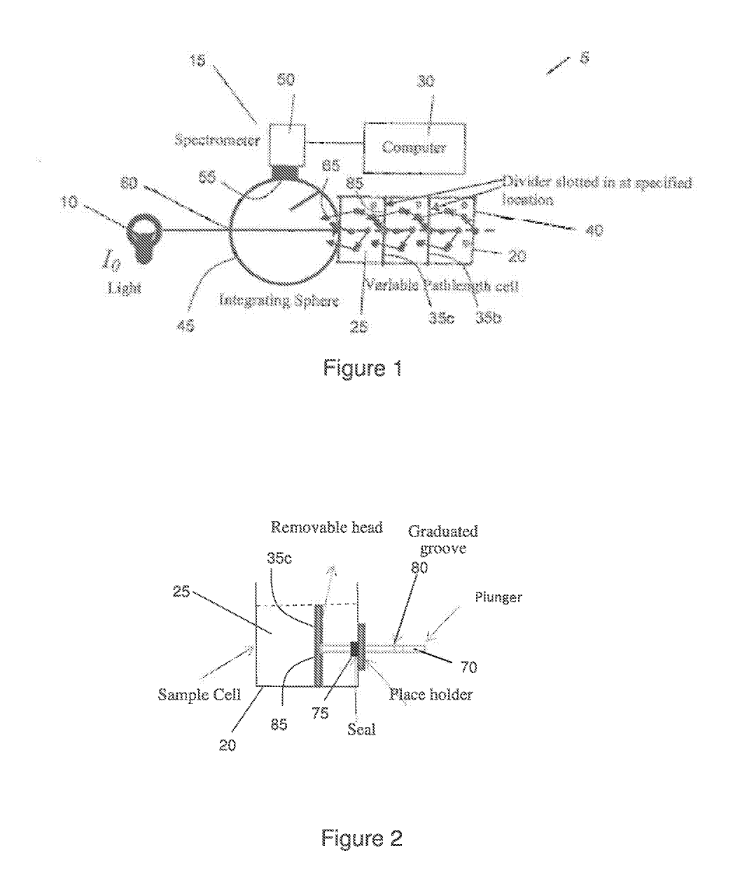

FIG. 1 shows an optical measurement system 5 comprising a radiation source 10, a detection system 15 and a sample holder 20 for holding a sample 25. An analysis unit 30 in the form of a suitably programmed and configured computer is coupled to the detection system 15. The system 5 is configured to be used in a transflective mode, wherein light reflected by the sample 25 and/or a divider 35a, 35b or back wail 40 of the sample holder 20 is detected by the detection system 15 and since the radiation passes through at least part of the sample before being reflected, properties of the sample associated with transmission of light through the sample may also be determined from the detected radiation. It will be appreciated that alternatively or additionally, the system 5 can be arranged so as to be used in a transmissive or reflective mode.

The radiation source 10 comprises a light source configured to emit light of selected wavelength(s). The light source may comprise any suitable light source known in the art such as a vapour lamp, an LED, a laser or the like.

The detection system 15 comprises an integrating sphere 45 and a spectrometer 50 for detecting radiation emitted from the integrating sphere 45 via a detection aperture 55. The integrating sphere 45 comprises a spherical enclosure having a reflective inner surface and opposing source and sample apertures 60, 65 such that light from the light source 10 may enter the integrating sphere via the source aperture 60 and pass straight through the integrating sphere 45 and out of the sample aperture 65.

The sample holder is positioned proximate the sample aperture 65 so as to receive radiation from the light source 10 via the sample aperture 65. The sample aperture 65 is also configured to allow light reflected and/or scattered from the sample 25 to enter the integrating sphere 45.

At least one measurement aperture 55 is also provided in the integrating sphere, the measurement aperture(s) 55 being positioned obliquely to the axis of the source and sample apertures 60, 65. The spectrometer 50 is positioned so as to receive light from the measurement aperture 55.

The sample holder 20 comprises a cuvette comprising a plurality of receiving portions (not shown), such as slots, for receiving one or more removable dividers 35a, 35b. The sample holder 20 is formed from suitable materials known in the art such as glass or quartz. The receiving portions are located such that the divider(s) 35a, 35b can be inserted into the receiving portions to divide the sample holder 20 in planes perpendicular to the axis of light received from the light source 10 via the sample aperture 65. A surface of the divider 35a, 35b faces the light source 10 when the divider 35a, 35b is inserted into the receiving portions of the sample holder 20.

The system comprises a plurality of dividers 35a, 35b, each divider 35a, 35b having a differing reflectivity. The surface 85 of the dividers 35a, 35b, 35c and/or rear wall 40 of the sample holder 20 that faces the light source 10 may be selected to achieve further measurement variations. For example, the dividers 35a, 35b, 35c or rear wall 40 of the sample holder 20 could comprise a reflective or mirrored surface, or a diffuse reflective surface or an opaque or blackened surface or a transmissive or transparent surface, for example, formed from glass or quartz.

In this way, the optical path length of light through the sample 25 and the reflectivity of a surface from which it is reflected after passing through at least part of the sample is controllable by inserting and/or removing dividers 35a, 35b having a selected reflectivity in a selected receiving portion.

It will be appreciated that other techniques for varying the path length of light may be used,

For example, as shown in FIG. 2, instead of removable dividers 35a, 35b that can be inserted into and removed from the sample holder 20, a slidable divider 35c may be used. For example, the divider 35c is removably mounted on a plunger 70 that extends through the rear wall 40 of the sample holder 20 via a seal 75 such that the divider 35c is slidably movable within the sample chamber towards and away from the sample aperture 65 of the integrating sphere 45 by actuating the plunger 70. In particular, the plunger 70 is provided with at least one mark, groove or stopping member 80 for engaging with the wall 40 of the sample chamber 20 so as to indicate that a predetermined position of the divider 35c has been reached. In this case the divider 35c is movable between a position where it abuts the rear wail 40 of the sample holder 20 and the predetermined position. This arrangement is particularly suitable for automated systems and the plunger 70 may be operable by an actuator such as a stepper motor or an electromagnetic or piezoelectric actuator, which may have calibrated motion, such that the mark, groove or stopping member 80 is not needed.

In an alternative approach, dimensionally different interchangeable sample holders may be provided to vary the path length between measurements. The walls of each sample holder are formed from the same material. However, it will be appreciated that using different sample holders has the drawback that variations in the cell surface may produce errors, which could be significant. Furthermore, using differing cells means that the same sample is not measured, since each sample holder would have to be filled separately.

Using the above arrangements, it will be appreciated that a series of measurements may be taken in which each measurement can be associated with a different path length of light through the sample and/or reflectivity of the surface of the divider 35a, 35b, 35c or sample holder wall 40. For example, two or more measurements may be taken in which the divider 35a, 35b, 35c has a diffuse reflective surface and each measurement is taken with a different path length (e.g. with the divider having a diffuse reflective surface in a different position). In another example, two or more transflectance measurements are made, wherein the divider 35a, 35b, 35c is provided with a mirrored surface and each measurement is taken with a different path length and divider position in a further example, two or more measurements may be made in which a divider 35a, 35b, 35c having an opaque surface is used and each measurement is taken with a different path length and divider position. In an additional example, a divider 35a, 35b, 35c having a transmissive surface is provided and two or more measurements are made having different path lengths and divider positions. It will be appreciated that other combinations are possible. For example, two or more measurements may be taken, wherein at least two of the measurements are made with differing dividers 35a, 35b, 35c having differing surfaces selected from amongst the four surfaces described above and wherein the path length/divider position may be the same or different.

By determining properties based on a plurality of such measurements having different path lengths through the sample and/or having different reflectivities, it is possible to extract both chemometric information such as species identification and chemical composition and structural information such as particle size and distribution and stability without having to move the sample, detector or light source. This results in a measurement system that provides a high degree of information with good reproducibility and without having to undergo time-consuming reorganisations.

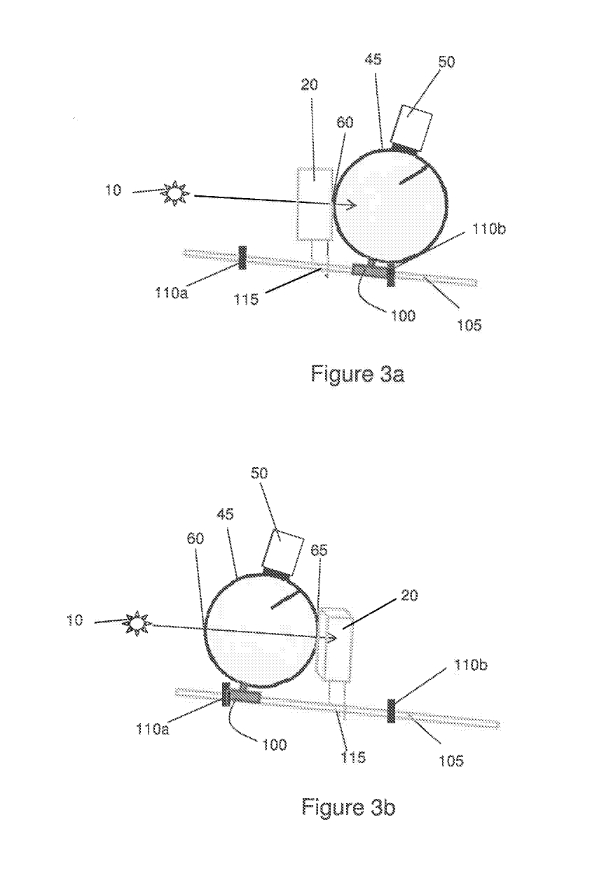

However, a user may prefer to conduct specific reflectance and transmission measurements, wherein the spectrometer 50 and integrating sphere 45 are provided between the sample 25 and the light source 10 for reflectance measurements, whilst the sample 25 is provided between the light source 10 and integrating sphere 45 and detector 50 for transmission measurements. Apparatus for doing this is illustrated in FIGS. 3a and 3b.

In the embodiment of FIGS. 3a and 3b, the detector system 15 comprises a spectrometer 50 mounted on an integrating sphere 45. The integrating sphere 45 is similar to that described above in relation to FIG. 1. However, in the present embodiment, the integrating sphere 45 is mounted to a carriage 100, which is slidably mounted on a rail 105 so as to be linearly moveable towards and away from the light source 10. The rail 105 is provided with a pair of stoppers 110a, 110b to limit motion of the carriage 100 and thereby the integrating sphere 45 in two extreme positions. In this way, the integrating sphere 45 is reproducibly movable between a first position closer to the light source 10 in which the carriage 100 abuts the first stopper 110a and a second position further from the light source 10 in which the carriage 100 abuts the second stopper 110b.

The sample holder 20 is detachably mounted to a mounting portion 115 of the optical measurement system 5. The mounting portion 115 may be comprised in, for example, the rail 105 or a housing (not shown). The sample holder 20 is configured so as to engage corresponding portions of the mounting portion 115, for example one or more protrusions of the sample holder 20 may engage corresponding recesses on the mounting portion 115 such that the sample holder 20 can be removed and reattached in substantially the same position and orientation to minimise issues with reproducibility.

In a first configuration, as shown in FIG. 3a, the detection system 15 is provided on a far side of the sample 25 from the light source 10 such that the carriage 100 abuts the stopper 110b furthest from the light source 10, i.e. the system is operable in a transmission mode wherein the detection system 15 is configured to detect light that has passed through the sample. Thereafter, if a reflectance measurement is required, then the sample holder 20 can be removed and the detection system 15 slid along the rails 105 to abut the stopper 110a closest to the light source 10, as shown in FIG. 6b. The sample holder 20 can then be re-attached by engaging the sample holder 20 with mounting portion 115. In this configuration, the detection system 15 is arranged to measure radiation that has been reflected from the sample. In this way, the system 5 is straightforwardly and reproducibly switchable between reflectivity and transmission configurations.

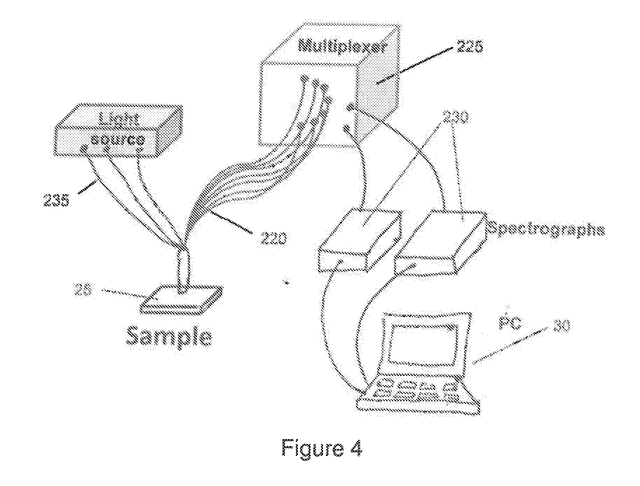

A further example of an implementation of this method is shown in FIGS. 4, 5 and 6, which show an optical probe 200 comprising a plurality of spatially separated sensing sites 205 and one or more (in this example five) light emitters 210a, 210b provided in a sensing surface 215 of the probe 200.

Each of the sensing sites 205 comprises an end of a corresponding optical fibre 220 which is coupled to a multiplexer 225. The multiplexer 225 is in turn coupled to one or more spectrographs 230. The multiplexer 225 is configured to selectively extract optical data from selected sensing sites 205 via the associated optical fibre 220 and to provide this to one or more of the spectrographs 230 for measurement.

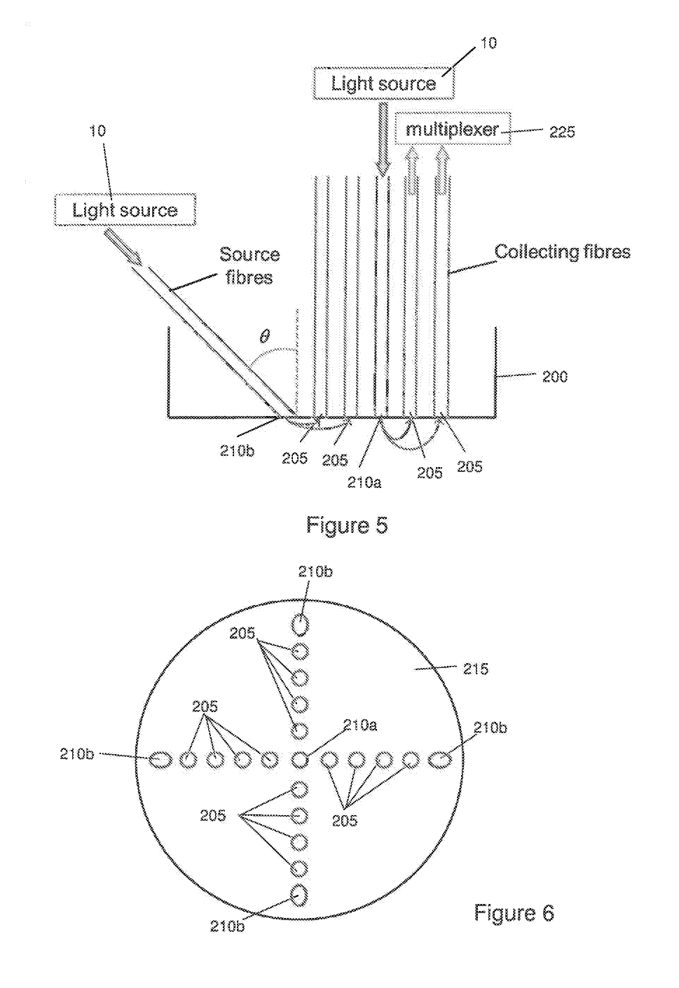

Each light emitter 210a, 210b comprises an end of an optical fibre 235 that is coupled to the light source 10 such that light can be selectively provided from the light source 10 to the light emitter 210a, 210b on the sensing surface 215. At least one of the light emitters 210b is orientated differently to at least one of the other light emitters 210a. For example, in the probe of FIG. 5, a central light emitter 210a is oriented perpendicularly to the sensing surface 215, whilst a plurality of peripheral light emitters 210b are oriented obliquely and toward a centre axis of the sensing surface 215.

In use, the sensing surface 215 of the probe 200 is provided in, adjacent or proximate the sample 25 to be analysed. A plurality of measurements having differing measurement parameters may be taken by selectively providing light from selected light emitters 210a, 210b and measuring the light received at selected sensing sites 205. As each of the light emitters 210a, 210b and sensing sites 205 are spatially separated, it will be appreciated that the path length through the sample 20 through which the light travels depends on the combination of light emitter and sensing site selected. Furthermore, the measurement may also be varied by selecting light emitters 210a, 210b having differing orientations such that the relative orientation of the light emitter 210a, 210b and sensing site 205 varies between measurements. In this way, a plurality of measurements associated with varying path length and relative orientation may be made, and properties of the sample 25 determined therefrom.

Contributions from reflected and transmitted components vary depending on the measurement arrangement selected (e.g. path length, reflectivity, etc.). In this way, appropriate analysis of the measurement data agar be performed in order to extract a full range of species identification and chemical composition data and also structural data such as particle size, distribution and stability.

There are various techniques that may be used to determine such properties from the measurement data. However, a particularly writable technique is described herein by way of example.

The process for determining the properties comprises constructing a trial solution using estimated values 705 and using these to solve a radiative transfer function in order to determine the reflectances and/or transmittances associated with the trial solution, using methods known in the art 710. Alternatively, variations or approximations of the radiative transfer function or other techniques such as the Kubelk-Munk theory can be used, for example, as described in references 1 and 2 below, which are hereby incorporated by reference.

For example, the reflectances and/or transmittances can be determined from the trial properties using the well-known adding-doubling method for calculating total diffuse reflectance and transmittance, for example, as described in references 3 and 4 below, which are hereby incorporated by reference. However, this technique is very time consuming.

Therefore, it is generally preferable to use techniques that use look-up tables to enable quicker processing. In this case, a look-up table can be built that comprises values of bulk optical properties at sufficiently small intervals and the corresponding reflectances and/or transmittances. These can be calculated theoretically in advance, e.g. by using the adding-doubling method or other techniques such as monte-carlo simulation or the like.

Using the look-up table, for a given set of reflectances and/or transmittances, the bulk optical properties can be estimated by interpolation of the closest tabulated values.

Alternatively, a calibration model can be built that takes as input the values of bulk optical properties (the estimated trial values in the above iterative procedure) and predicts the values that the combination of measurements would have if the sample's optical properties were the same as the guessed values. The model can be built using multivariate calibration techniques such as principal component analysis, partial least squares or using neural networks. The calibration models are built using a calibration set generated using the adding-doubling or monte-carlo methods or any other suitable methods depending on the theory of light propagation being used.

Another approach is to prepare standard or model samples, which will have a similar range of optical properties as the samples of interest would have. The optical properties of these model systems can be well characterised and controlled and can be calculated from first principles such as by using Mie Theory or similar methods, as described in reference 5 below, which is hereby incorporated by reference. Measurements are made on these standard or model systems and the look-up table of optical properties and the corresponding set of measurements are constructed using these measurements. This look-up table can be used with any of the other methods described above.

The reflectances and/or transmittances calculated from the trial properties can then be compared with the corresponding measured experimental data 715. A quality of fit function that is dependent on the difference between the reflectances and transmittances calculated from the trial properties and the measured values from each measurement is determined.

The quality of fit function is compared to a threshold 720 and the trial parameters will be rejected if the fit is above the threshold. An iterative process is then carried out in which the trial properties are varied 725 to generate new trial properties and the associated transmittances and reflectances for the new trial properties are then calculated 710 and compared to each of the measurements made 715. This process is iteratively repeated, for example using techniques such as monte-carlo simulated annealing, principal component analysis, partial least squares, neural networks, genetic algorithms or the like, to minimise the quality of fit function. Once the quality of fit function is below a threshold 720, the values of the properties of the trial model are taken as the values associated with the sample 730.

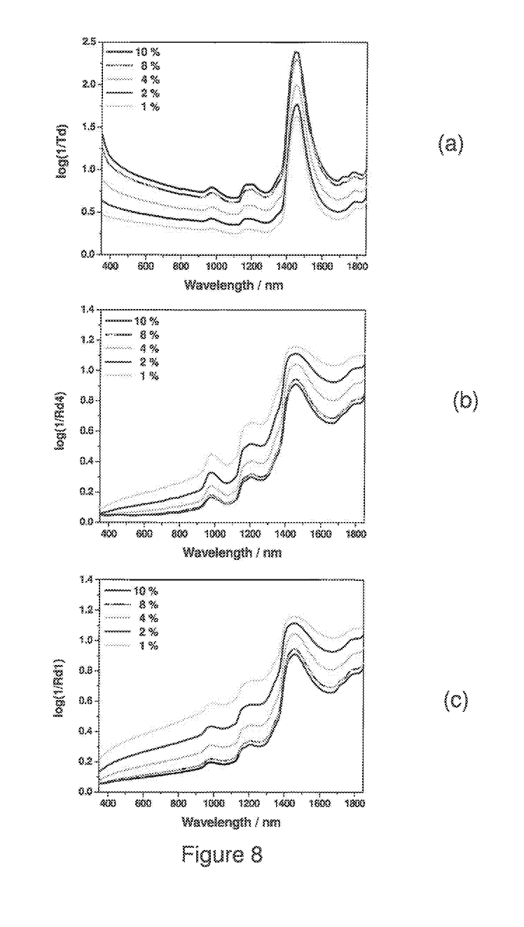

As an example, consider an instrument that uses an integrating sphere, such as that shown in FIGS. 1, 3a and 3b, to provide the following measurements: Total diffuse reflectance using a 1 mm sample thickness (Rd1), total diffuse reflectance using a 4 mm sample thickness (Rd4) and total diffuse transmittance using a 1 mm sample thickness at a plurality of wavelengths. The spectra so acquired are shown in FIGS. 8(a), 8(b) and 8(c). The samples in this example were made of 1-10% emulsified soya milk. While the spectra in this case were acquired by placing samples in cuvettes of different path lengths, similar results could be obtained with a variable path length sample holder design, such as that shown in FIG. 2. At each wavelength λ at which the measurements were made, an inversion algorithm is applied (in this example the inverse adding-doubling method was as described in references 3 and 4 below) to obtain the bulk optical properties of the sample, namely the bulk absorption coefficient μₐ(λ), bulk scattering coefficient μₛ(λ) and the anisotropy factor g(λ). This process is repeated for all the wavelengths at which the measurements were made. It is usual to combine the bulk scattering coefficient and the anisotropy factor, both of which are related to the scattering properties of the sample into a single parameter called the reduced bulk scattering coefficient μₛ′(λ)=μₛ(1−g). It should be noted that the inverse adding-doubling method is traditionally applied to a set of measurements that consist of total diffuse reflectance, total diffuse transmittance and collimated transmittance obtained for using the sample in the same cell i.e. the sample thickness is the same for all the three of the aforesaid measurements. In the present example, the adding-doubling method was modified to calculate the values of reflectances at two different sample thicknesses namely, 1 mm and 4 mm.

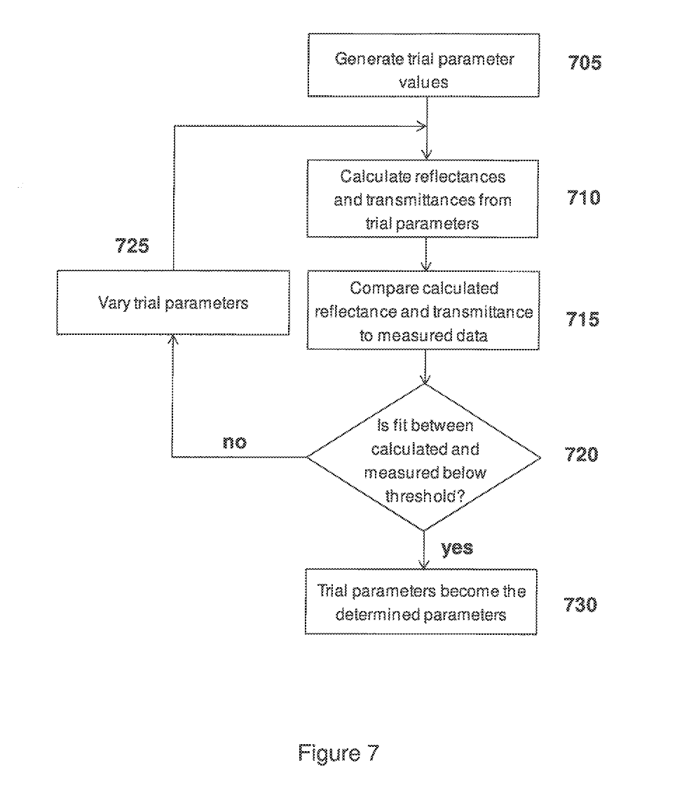

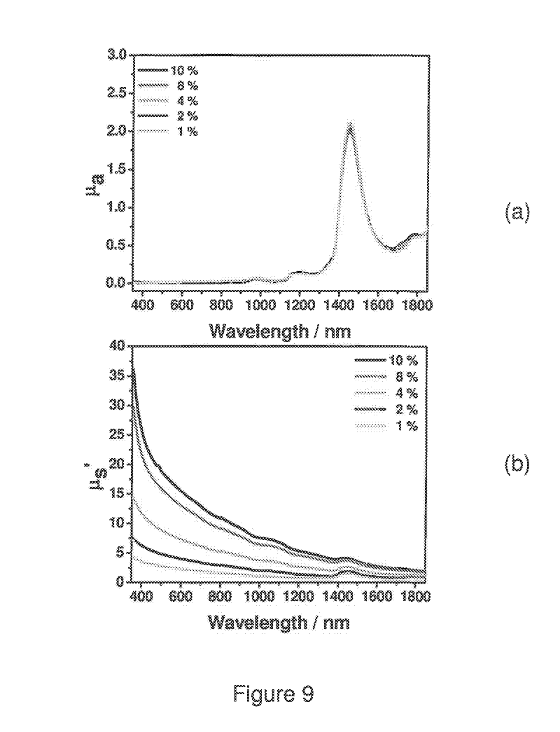

At each wavelength, the iterative procedure shown in FIG. 7 is started by providing trial parameter values to calculate reflectances (Rd1 and Rd4) and transmittance (Td1) using the adding-doubling method for solving the transport equation. The calculated and measured reflectances and transmittances were then compared to the corresponding measured values. The differences between the measured and the calculated values are used to update the trial parameter values. For this purpose, standard optimisation techniques can be used. For this example, the function Fmincon available in the MATLAB® optimization toolbox was used. The iteration is carried out until the convergence to within a preset tolerance is reached. For the samples considered here, the bulk optical properties μₛ and μₛ′ so obtained from the spectral measurements given in FIGS. 8(a), 8(b) and 8(c) are respectively shown in FIGS. 9(a) and 9(b).

The above specific examples are provided by way of illustration. It will be appreciated that variations to the examples given above may be made without departing from the scope of the invention as defined by the claims. In particular, although the above system 5 is advantageously described as being in a transflective configuration, it will be appreciated that a transmissive or reflective arrangement or a system that is switchable between the two may also be used. Furthermore, whilst light emitters 210a, 210b that comprise fibre optic cable 235 from a light source 10 are described, it will be appreciated that other light emitting means such as micro-LEDs or solid state lasers may be used. Whilst the probe 200 described above advantageously comprises obliquely angled light emitters 210b, it will be appreciated that alternatively or additionally, the detecting optical fibres 205 may be angled obliquely to the sensing surface. Therefore, the above specific examples are provided by way of illustrative example only and the scope of the invention is defined by the claims.

### REFERENCES

(1) Sirita, J.; Phanichphant, S.; Meunier, F. C. Analytical Chemistry 2007, 79, 3912-3918.
(2) Thennadil, S. N. Journal of the Optical Society of America a-Optics image Science and Vision 2008, 25, 1480-1485.
(3) Steponavicius, R.; Thennadil, S. N. Analytical Chemistry 2011, 83, 1931.
(4) Steponavicius, R.; Thennadil, S. N. Analytical Chemistry 2009, 81, 7713-7723.
(5) Bohren, C. H.; Huffman, D. R. Absorption and scattering of light by small particles, John Wiley and Sons, New York.

1-38. (canceled)

39. A measurement system comprising a radiation source and a detection system, wherein the radiation source is arranged or arrangeable such that radiation from the radiation source is incident on a sample and the detection system is configured or configurable to receive at least part of the radiation via the sample, wherein the system is reconfigurable so as to vary a path length that the radiation travels through the sample and/or a reflectance of at least one surface upon which the radiation is incident after passing through at least part of the sample.

40. The measurement system according to claim 39, wherein the measurement system comprises a sample holder, the sample holder being positioned or positionable so as to receive radiation from the radiation source.

41. The measurement system according to claim 39, wherein the measurement system is configured such that at least part of the radiation from the radiation source passes through at least part of the sample.

42. The measurement system according to claim 39, wherein the measurement system is configured to collect at least a first measurement of radiation that has passed through at least a first path length through the sample and/or been reflected from a surface having a first reflectance after passing through at least part of the sample and a second measurement of radiation that has passed through at least a second path length through the sample and/or has been reflected from a surface having a second reflectance after passing through at least part of the sample.

43. The measurement system according to claim 42, wherein the measurement system is configured to determine a property of the sample based on at least the first and second measurements.

44. The measurement system according to claim 41, wherein the measurement system is configured to make multiple measurements, each measurement being associated with a different radiation path length through the sample and/or reflectivity of a surface from which the radiation has been reflected after passing through at least a part of the sample relative to at least one other measurement.

45. The measurement system according to claim 40, wherein the sample holder comprises a sample chamber for holding the sample, wherein the sample chamber is divided or dividable into sections.

46. The measurement system according to claim 45, wherein the sample holder comprises at least one fitting for receiving a divider for the sample chamber and/or at least one divider for dividing the sample chamber.

47. The measurement system according to claim 46, wherein at least one of a divider or a back wall of the sample holder comprises a facing surface that is configured or configurable to face the radiation source, wherein the facing surface comprises a reflective or mirrored surface or a diffuse reflective surface or an opaque or blackened surface or a transmissive or transparent surface.

48. The measurement system according to claim 45, wherein the divider is movable within the sample chamber,

49. The measurement system according to claim 48, wherein the divider is mounted to a movable member comprise at least one marker for marking a range of motion of the movable member and/or at least one stopping member for limiting the motion of the divider at a predetermined position in the sample chamber.

50. The measurement system according to claim 40, wherein the measurement system comprises Interchangeable sample holders of varying dimensions, wherein at least the first and second path lengths are defined by the dimensions of differing sample holders and/or the first and second reflectivities are defined by differing reflectivities of at least one surface of differing sample holders.

51. The measurement system according to claim 40, wherein the detection system is movably mounted on guide apparatus so as to be movable relative to the sample holder and/or radiation source.

52. The measurement system according to claim 40, wherein the sample holder is movable or removable and the guide apparatus or a housing of the measurement system comprises placing means or fixing points for mounting the sample holder in a predetermined position and/or orientation.

53. The measurement system according to claim 43, wherein the measurement system comprises, or is configured to communicate with, processing apparatus, the processing apparatus being adapted to determine at least one property of the sample based on at least the first and second measurements.

54. The measurement system according to claim 53, wherein the processing apparatus is configured to determine the at least one property of the sample by fitting theoretically calculated parameters based on a trial model against the two or more measurements and/or to determine at least one property by comparing measurement data with reference data, which may be stored in a database or look up table.

55. The measurement system according to claim 39, wherein the measurement system comprises a measurement probe.

56. The measurement system according to claim 55, wherein a plurality of optical fibres are comprised in the measurement probe such that at least one optical fibre is spaced apart from at least one other optical fibre and/or at least one optical fibre Is oriented at a different angle relative to at least one other optical fibre.

57. The measurement system according to claim 56, wherein the one or more optical fibres are connected or connectable to a multiplexer and the multiplexer Is connected to a detector.

58. The measurement system according to claim 55, wherein the measurement probe comprises at least one light emitter.

59. The measurement system of claim 58, wherein at least one light emitter comprises an end of one of the optical fibres, and another end of the optical fibre being connected or connectable to the radiation source.

60. The measurement system according to any of claim 57, wherein the detector is configured to record radiation intensity at a number of wavelengths.

61. The measurement system according to any of claim 42, wherein the system is configured to collect both reflected and transmitted radiation, which corresponds to respective first and second measurements.

62. A method of collecting optical measurements using a measurement system comprising a radiation source and detection system, the method comprising:
configuring the system such that radiation from the radiation source passes through the sample along a first path length and/or is reflected from a surface having a first reflectivity;
performing at least a first measurement that comprises measuring radiation from the sample after having passed through the first path length and/or having being reflected from the surface having the first reflectivity;
configuring the system such that radiation from the radiation source passes through the sample along a second path length and/or is reflected from a surface having a second reflectance;
performing at least a second measurement that comprises measuring radiation from the sample after having passed through the second path length and/or having being reflected from the surface having the second reflectivity;
determining at least one property of the sample from at least the first and second measurements.

63. An optical measurement system comprising a radiation source and detection system, wherein the detection system is mounted to a guide for moving the detection system between at least two collinear positions.

64. The optical measurement system according to claim 63, wherein the detection system is linearly movable.

65. The optical measurement system according to claim 63, wherein the system comprises a sample holder and the detection system is movable between a side of the sample holder towards the radiation source and a side of the sample holder away from the radiation source.

66. The optical measurement system according to claim 63, wherein the guide comprises at least two stopping means for limiting motion of the defection system in a corresponding predetermined position or positions.

67. The optical measurement system according to claim 63, wherein the sample holder is movable or removable, and the guide or a housing of the optical measurement systems comprises placing means or fixing points for mounting the sample holder in a predetermined position and/or orientation.

68. A sensor probe comprising two or more optical fibres for detecting radiation from a sample, wherein the at least one of the optical fibres is spaced apart from at least one other optical fibre and/or at least one optical fibre is angled with respect to at least one ether of the optical fibres.

69. The measurement probe according to claim 68, wherein the sensor probe comprises at least one Sight emitter, wherein the light emitter comprises an end of an optical fibre for receiving light from a light source.

70. A processing system for processing measurements collected using the apparatus according to claim 39.

71. A computer program product comprising at least one non-transitory computer-readable storage medium having computer-readable program code portions stored therein, the computer-readable program code portions comprising one or more executable portions for implementing the system of claim 39.

72. A sample holder, the sample holder comprising a sample chamber for holding the sample, wherein the sample chamber is divided or dividable into sections and/or the sample holder comprises a movable divider for varying a dimension of the sample chamber.
